(19) United States
(12) Patent Application Publication
(10) Pub. No.: US 2014/0149359 A1
(43) Pub. Date: May 29, 2014

(54) SYSTEM FOR VERIFYING CORRECTNESS OF DATA WHEN DATA ARE REQUESTED AND METHOD THEREOF

(71) Applicants: INVENTEC (PUDONG) TECHNOLOGY CORPORATION, Shanghai (CN); INVENTEC CORPORATION, Taipei (TW)

(72) Inventor: Dong Hai LI, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/794,913

(22) Filed: Mar. 12, 2013

(30) Foreign Application Priority Data
Nov. 29, 2012 (CN) 201210501133.8

(51) Int. Cl. G06F 11/08

(52) U.S. Cl. CPC G06F 11/08
USPC 707/687

(57) ABSTRACT

A system for verifying correctness of data when the data are requested and the method thereof read target paragraphs from a target file to verify whether each of target paragraphs is correct or not. When the target paragraphs are correct, the target paragraphs are sent to the client requesting the target file. The system and the method can provide verified and correct data to the user, achieving the goal of verifying part of target file and reducing the verifying time.

### BACKGROUND OF THE INVENTION

1. Field of Invention

The invention relates to a data verifying system and the method thereof. In particular, the invention relates to a system for verifying a correctness of data when the data are requested and the method thereof.

2. Related Art

When a user accesses data using network hard disk service, whether the content of the information being read out is the same as original one is the most important part. In general, a primary cause for data inconsistence between the written and readout data is damaged storage media.

Currently, when a user wants to verify the information, the CRC, MD5, SHA-1 authentication algorithms are often used on the data to be verified. The verifying calculation value is compared with the expected verifying default value to determine whether the data are correct.

When the user uses a verifying algorithm to determine whether the information is correct, he or she often needs to download or install a program that provides the verifying algorithm. This is inconvenient for the user. If the user does not need to obtain all the information but only part of it, he or she still has to use the verifying algorithm on all the information so that the computed verifying calculation value can be used to determine whether the information is correct. When the amount of data is very large, it is a waste of time.

In summary, the prior art always has the problem that it is a waste of time for the user to verify the correctness of information by himself. It is thus necessary to provide an improved means to solve this problem.

### SUMMARY OF THE INVENTION

In view of the foregoing, the invention discloses a system for verifying a correctness of data when the data are requested and the method thereof.

The disclosed system is used on the server. The server has a storage media, and is provided for the connections of clients. The system includes at least: a transmission module for receiving a read request sent from a client for reading a target paragraph in a target file; a data access module for reading the content of the target paragraph from the storage media; a verification value calculation module for computing a verifying calculation value corresponding to the target paragraph according to the data content; a verification value comparison module for reading the verifying default value corresponding to the target paragraph from the storage media and comparing the verifying default value and the verifying calculation value of the target paragraph; wherein when the verifying default value and the verifying calculation value of the target paragraph agree, the transmission module transmits the target paragraph to the client.

The disclosed method is used on a server, which is provided for the connections of clients. The method includes at least the steps of: receiving a read request sent from a client for reading a target paragraph in a target file; reading a verifying default value corresponding to the target paragraph; reading the data content of the target paragraph; computing a verifying calculation value corresponding to the target paragraph in accordance with the data content; comparing the verifying calculation value corresponding to the target paragraph with the verifying default value; and transmitting the target paragraph to the client when the verifying calculation value corresponding to the target paragraph agrees with the verifying default value.

The disclosed system and method differ from the prior art in that the invention reads out target paragraphs from the target file and verifies whether each of the target paragraphs is correct. When the target paragraph is correct, the invention sends the target paragraphs to the client. The invention solves the problems in the prior art, and achieves the goal of only verifying partial contents of the target file, thereby reducing the verifying time.

### BRIEF DESCRIPTION OF THE DRAWINGS

The invention will become more fully understood from the detailed description given herein below illustration only, and thus is not limitative of the present invention, and wherein:

FIG. 1 is a structural diagram of the disclosed system for verifying data correctness when data are requested.

FIG. 2 is a schematic view showing the correspondence of the target paragraph and the verification default value.

FIG. 3A is a flowchart of the disclosed method for verifying data correctness when data are requested.

FIG. 3B is a flowchart of the disclosed method for establishing the verification default value when data are uploaded.

### DETAILED DESCRIPTION OF THE INVENTION

The present invention will be apparent from the following detailed description, which proceeds with reference to the accompanying drawings, wherein the same references relate to the same elements.

When a client asks for target paragraphs stored in a target file, the server reads out the requested target paragraphs from the target file and verifies the correctness of the data contents of each of the target paragraphs. The target paragraph referred herein is a storage block of a certain size in the storage media that stores the target file. In general, the size of the target paragraph has a default value. For example, the target paragraph can have the size of a sector of the storage media sector or any other arbitrary size. It may be set by the user. The invention does not impose any restriction on this.

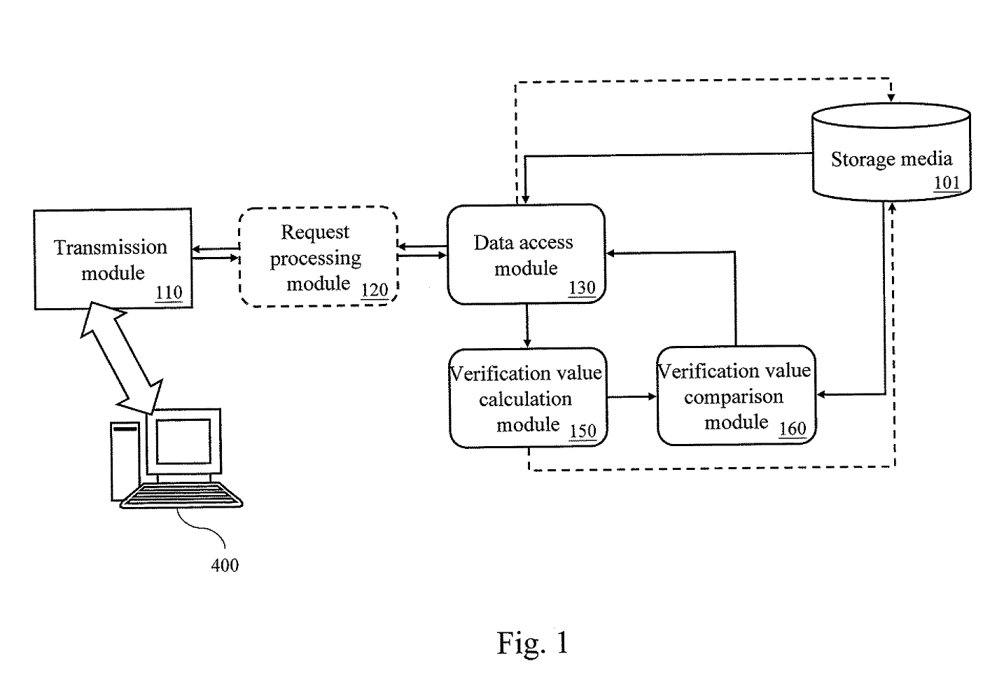

FIG. 1 is a diagram of the system for verifying the correctness of data when data are requested. As shown in FIG. 1, the system running on a server (not shown) comprises a transmission module 110, a data access module 130, a verification value calculation module 150, and a verification value comparison module 160.

The transmission module 110 receives a request sent from a client 400. When the client 400 wants to read one or more target paragraphs in the target file, the client 400 sends a read request to the server. The transmission module 110 receives the read request transmitted from the client 400. When the client 400 wants to write target data to the target file, the client 400 sends a write request containing the target data to be saved to the server. The transmission module 110 also receives the write request sent from the client 400. The target file to be read or written by the client 400 is stored in the storage media 101 of the server.

Suppose the client 400 wants to read a target paragraph in the target file. That is, after the transmission module 110 receives the read request transmitted from the client 400, the transmission module 110 sends the target paragraph read out by the data access module 130 to the client 4 when the verification value comparison module 160 compares the verification default value and the verification calculation value and find agreement. The verification value comparison module 160 will be described later.

The data access module 130 reads from the storage media 101 of the server the target paragraph corresponding to the read request received by the transmission module 110. That is, it reads the data content in the target file requested by the client 400.

It should be noted that the target paragraph corresponding to the read request can be a complete target file, or partial contents of the target file. The invention has not particular restriction on this. In some embodiments, when the target paragraph corresponding to the read request is part of the target file, then the data access module 130 determines the target paragraph to be read based on the read request. For example, the read request contains the starting byte and the length of the data in the target file as requested by the client 400. The data access module 130 uses the starting byte and the length to determine the target paragraphs to be read. As another example, when the target file contains multiple files, the read request may contain one or more files in the target file. The data access module 130 determines the target paragraphs of the requested file according to the file name in the read request. But the method that the data access module 130 reads the target paragraphs is not limited to the above-mentioned examples.

Besides, suppose the storage media 101 stores more than one target files. When the verification value comparison module 160 determines that the verification default value and the verification calculation value corresponding to the target paragraph are different, the data access module 130 reads the backup content of the target paragraph with different verification default value and verification calculation value. For example, the storage media 101 employs, for example, the RAID-1 technology. Then different disks in the storage media 101 contain one copy of the target file. When the verification value comparison module 160 determines that the verification default value and the verification calculation value corresponding tot he target paragraph are different, the data access module 130 tries to read from the storage media 101 the backup content of another target file. In this case, the backup content read out by the data access module 130 may be different from that of the previous readout.

In some embodiments, the data access module 130 is also responsible for writing the target data in the write request received by the transmission module 110 into the target file stored in the storage media 101.

The verification value calculation module 150 computes the verification calculation value corresponding to the target paragraph. The verification calculation module 150 can use the Cyclic Redundancy Check (CRC), the Message-Digest Algorithm 5 (MD5), or the Secure Hash Algorithm (SHA) to compute the verification calculation values. The algorithm used by the verification value calculation module 150 is not limited to the above examples, as long as the correctness of data can be verified.

In addition to reading out the content of the target paragraph, the data access module 130 may also read out the backup content of the target paragraph. The verification value calculation module 150 computes the verification calculation value corresponding to the target paragraph according to the data or backup contents read out by the data access module 130.

In some embodiments, the data access module 130 writes the target data to the target file. When the target file to which the data access module 130 writes the target data already exists, all or part of the target paragraphs therein may be updated.

When the target paragraphs in the target file are updated by the data access module 130, the verification value calculation module 150 uses the same algorithm as the computation of the verification calculation value to compute the verification values of the updated target paragraphs. The newly calculated verification values are the verification default values of the invention.

Moreover, after computing the verification default values, the verification value calculation module 150 also saves them to the storage media 101 of the server. The verification value calculation module 150 can compute the verification default values of all target paragraphs in the newly established target file. It also computes the verification default values of the updated target paragraphs in the target file when the established target file is updated.

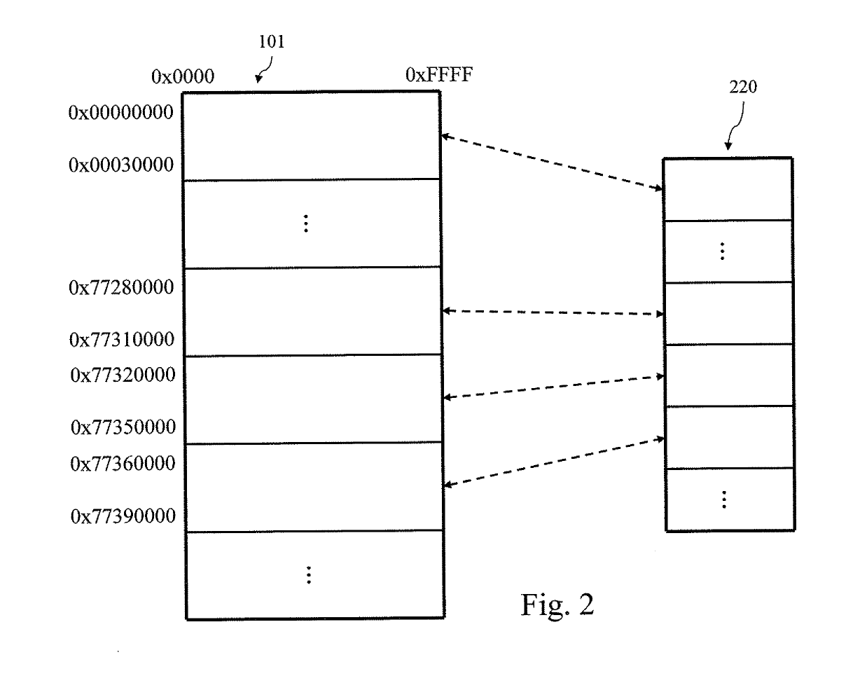

Generally speaking, the verification default values can be stored in a database in the storage media 101. The present invention, however, is not limited to this possibility. Any method that can correctly store the verification default values should be within the scope of the invention. For example, the verification default values may be stored in the array 220 shown in FIG. 2, wherein the n-th element in the array 220 represents the verification default value of the n-th target paragraph in the storage media 101. For example, when the size of each target paragraph in the storage media 101 is 256K bytes, the target paragraph of the storage address 0x77280000˜0x7731FFFF is stored in the 1932-th target paragraph of the storage media 101. The verification default value of the target paragraph is then stored in the 1932-th element of the array 220.

The verification value comparison module 160 reads from the storage media 101 of the server the verification default value corresponding to the target paragraph and compares the readout verification default value with the verification calculation value obtained by the verification value calculation module 150 for the target paragraph.

In general, the verification value comparison module 160 reads the verification default value according to the identification information of the target paragraph or the order of the target paragraph in the storage media 101. But the present invention is not limited to this possibility, as long as the verification value comparison module 160 can read the corresponding verification default values. The identification information of the target paragraph includes, but not limited to, the starting position of the target paragraph in the storage media 101.

Besides, the request received by the transmission module 110 may be a read request or a write request. Accordingly, the invention can include a request processing module 120 for determining whether the request received by the transmission module 110 is a read request or a write request so that the subsequent modules can operate smoothly.

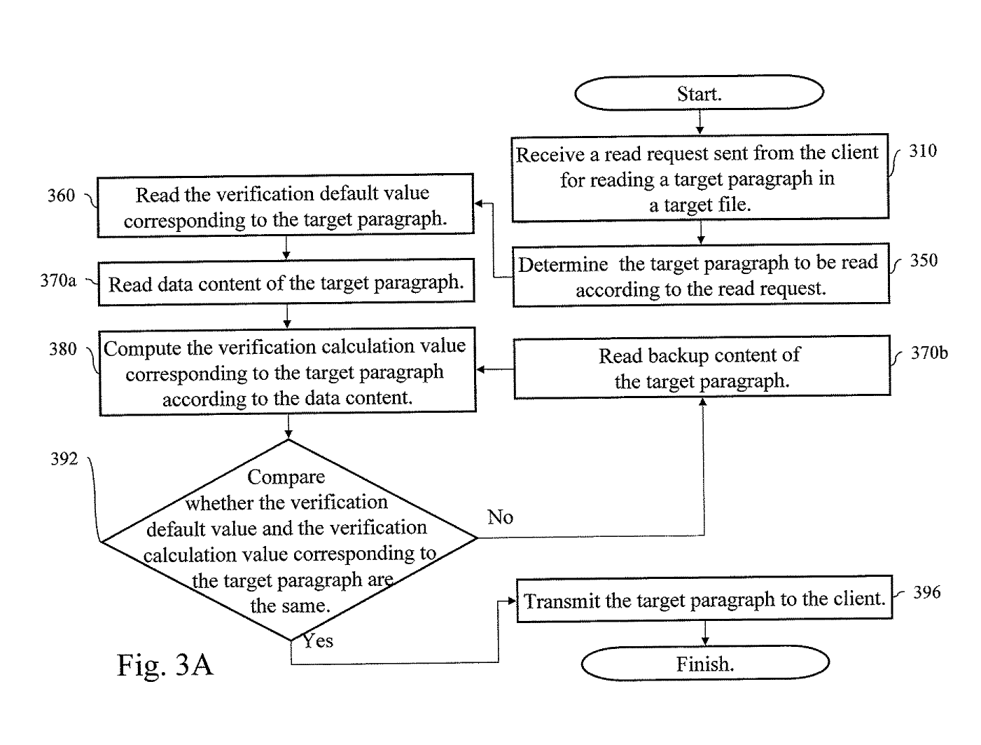

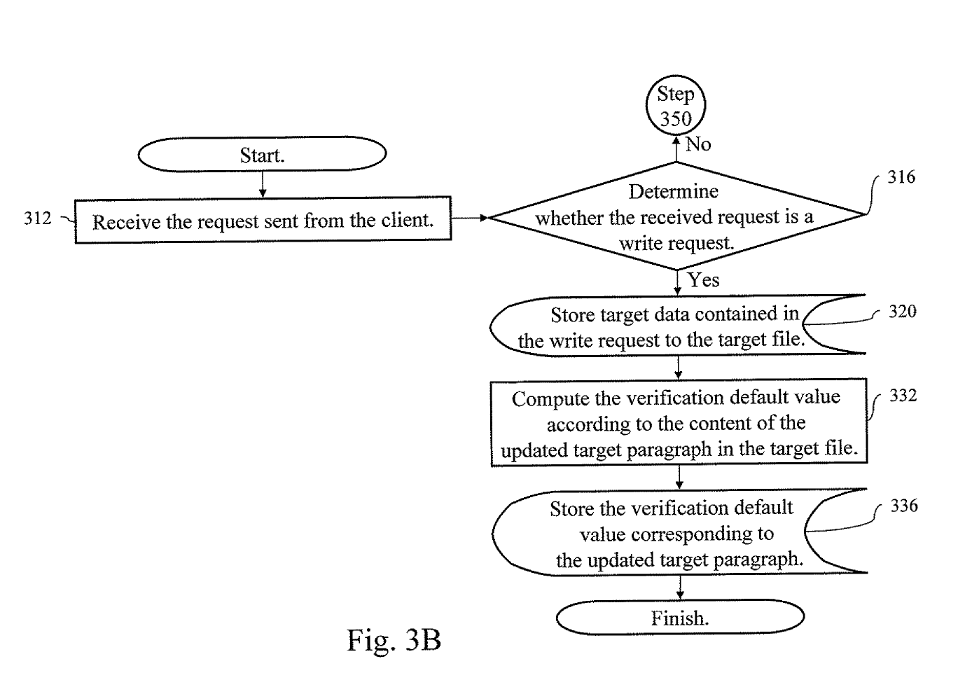

In the following, one embodiment is employed to explain the operation of the disclosed system and method. FIG. 3A is a flowchart of the disclosed method for verifying the correctness of data when data are requested. In this embodiment, the invention is implemented on a file server. But the present invention is not limited to this example.

When a client 400 wants to read a target file, the client 400 can send over the network a read request to read the target file to the file server of the invention. In this embodiment, the target file is assumed have a size of 413K bytes.

After the transmission module 110 receives the read request transmitted by the client 400 (step 310), the verification value comparison module 160 reads the verification default value corresponding to the target paragraph in the read request from the storage medium 101 (step 360). In this embodiment, suppose the client 400 wants to read the complete target file, and the target file is stored in the two ranges 0x77280000˜0x772DFFFF and 0x88280000˜0x8829FFFF of the storage media 101. If the target paragraph size is 128K, then the target file is stored in the four target paragraphs: 0x77280000 to 0x7729FFFF, 0x772A000 to 0x772BFFFF, 0x772C000 to 0x772DFFFF, and 0x88280000 to 0x8829FFFF. Therefore, the verification value comparison module 160 read the verification default values of the above-mentioned four target paragraphs from the verification database stored in the storage media 101.

After the transmission module 110 receives the read request transmitted from the client 400 (step 310), the data access module 130 reads the data content of the target paragraph corresponding to the read request from the storage medium 101 (step 370a). The verification value calculation module 150 computes the verification calculation value corresponding to the target paragraph according to the data content read out by the data access module 130 (step 380). In this embodiment, the data access module 130 reads the data contents of the four target paragraphs from the addresses 0x77280000 to 0x7729FFFF, 0x772A000 to 0x772BFFFF, 0x772C000 to 0x772DFFFF, and 0x88280000 to 0x8829FFFF. The verification value calculation module 150 computes the verification calculation values of the four data contents read out by the data access module 130.

In practice, the verification value comparison module 160 reads the verification default value corresponding to the target paragraph (step 360). The data access module 130 reads the data content of the target paragraph (step 370a). The verification value calculation module 150 calculates the verification calculation value corresponding to the target paragraph based on the data content (step 380). These steps do not have a fixed order.

After the verification value comparison module 160 reads the verification default value corresponding to the target paragraph (step 360), and the verification value calculation module 150 computes the verification calculation value corresponding to the target paragraph according to the data content (step 380), the verification value comparison module 160 compares whether verification default value of the target paragraph and the verification calculation value are the same (step 392). If they are the same value, the transmission module 110 can send the target paragraph whose verification default value and verification calculation value are the same to the client 400 (step 396).

In this embodiment, the verification value comparison module 160 compares the verification default value and verification calculation value of the target paragraph in the addresses 0x77280000 to 0x7729FFFF. If they are the same, the transmission module 110 sends the data content oft he target paragraph in the addresses 0x77280000 to 0x7729FFFF to the client 400. Afterwards, the verification value comparison module 160 continues to compare the verification default value and verification calculation value corresponding to the target paragraph in 0x772A000 to 0x772BFFFF. Likewise, it also compares the verification default values and verification calculation values corresponding to the addresses 0x772C000, to 0x772DFFFF and 0x88280000 to 0x8829FFFF. When the comparison result shows that the verification default value and verification calculation value agree, the transmission module 110 sends the data contents oft he target paragraphs corresponding to the addresses 0x772A000 to 0x772BFFFF, 0x772C000 to 0x772DFFFF, and 0x88280000 to 0x8829FFFF to the client 400.

When the verification value comparison module 160 finds that the verification default value and the verification calculation value are different, the data access module 130 tries to find whether the target paragraph has a backup content in the storage media 101. If there is a backup, the data access module 130 reads out the backup contents of the target paragraph (step 370b). The verification value calculation module 150 recalculates the verification calculation value corresponding tot he target paragraph in accordance with the readout backup content (step 380). The verification value comparison module 160 further compares the verification default value read out from the storage media 101 and the verification calculation value recalculated by the verification value calculation module 150 (step 392), until all the verification default values and the verification calculation values are the same or the data access module 130 cannot read out any other backup content. If the verification default corresponding to the target paragraph and the verification calculation value are the same, the transmission module 110 sends the target paragraph read out by the data access modules 130 to the client 400 (step 396). If the data access module 130 cannot read out any other backup content, the transmission module 110 sends a data error message to the client 400.

Thus, the present invention can verify the correctness of the data on the server to be read by the client 400 before the data are downloaded.

In addition, the client 400 can also send a write request for writing target data into a target file to the file server.

As shown in FIG. 3B, after the transmission module 110 receives the request sent by the client 400 (step 312), the request processing module 120 determines whether the request received by the transmission module 110 is a write request (step 316). If not, the transmission module 110 receives a read request. The verification value comparison module 160 reads the verification default value corresponding to the target paragraph (step 360). The verification value calculation module 150 computes the verification calculation value corresponding to the target paragraph according to the data content (step 380). Thus, each module of the invention will continue to operate as mentioned above.

If the transmission module 110 receives a write request, the data access module 130 stores the target data in the write request to the target file (step 320). The verification value calculation module 150 computes the verification value based on the data content of the target paragraph in the target file updated by the data access module 130 (step 332). The computed verification value for the updated target paragraph is stored in the storage media 101 as verification default value of the updated target paragraph (step 336), so that the client 400 can verify the correctness of the target paragraphs in the target file subsequently.

In the above embodiment, suppose the read request of the client 400 contains the starting address and the length. Suppose that the starting address is 0x11000 and the length is 69K. It means that the client 400 wants to read the data contents of the two target paragraphs in 0x77280000 to 0x7729FFFF and in 0x772A000 to 0x772BFFFF. Therefore, the verification value comparison module 160 reads the verification default values of the two target paragraphs from the verification database in the storage media 101. At the same time, the data access module 130 also reads from the storage media 101 the data content of the target paragraphs corresponding to the read request (step 370a); that is, reading the data contents of the two target paragraphs in 0x77280000 to of 0x7729FFFF and in 0x772A000 to 0x772BFFFF.

After the verification value calculation module 150 computes the verification calculation value corresponding to the target paragraph according to the data content read out by the data access module 130 (step 380), the verification value comparison module 160 compares whether the verification default value of the target paragraph agrees with the verification calculation value (step 392). If they agree, the transmission module 110 sends the target paragraph whose verification default value and verification calculation value agree to the client 400 (step 396).

In summary, the present invention differs from the prior art in the following aspects. The invention reads the target paragraphs from the target file and verifies whether each of the target paragraphs is correct. Only when the target paragraph is correct is the target paragraph sent to the client. This technique solves the problem in the prior art that it is time-consuming for the user to verify data correctness. It achieves the goals of verifying only part of the target file and reducing the verification time.

Furthermore, the disclosed method can be realized in hardware, software, or a combination of hardware and software. It can also be implemented in a computer system in a centralized manner, or scattered in different computers in an interconnected computer system.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for verifying correctness of data when data are requested implemented on a server for the connection of at least one client, comprising the steps of:
receiving a read request sent from the client for reading at least one target paragraph of a target file;
reading a verification default value corresponding to the target paragraph;
reading data content of the target paragraph;
computing a verification calculation value corresponding to the target paragraph according to the data content;
comparing the verification default value and the verification calculation value corresponding to the target paragraph; and
sending the target paragraph to the client when the verification default value and the verification calculation value corresponding to the target paragraph agree.

2. The method of claim 1 further comprising the steps of: reading a backup content of the target paragraph when the verification default value and the verification calculation value corresponding to the target paragraph disagree; recalculating the verification calculation value corresponding to the target paragraph according to the backup content; and comparing again the verification default value and the verification calculation value corresponding to the target paragraph

3. The method of claim 1, wherein the step of receiving a read request sent from the client for reading at least one target paragraph of a target file is preceded by the step of determining the target paragraphs to be read according to the read request.

4. The method of claim 1, wherein the step of receiving a read request sent from the client for reading at least one target paragraph of a target file is preceded by the steps of: receiving a write request sent from the client for writing target data to the target file; storing the target data in the write request into the target file; calculating the verification default value according to the content of the updated target paragraph in the target file; and storing the verification default value corresponding to the updated target paragraph.

5. A system for verifying correctness of data when data are requested implemented on a server with a storage media for the connection of at least one client, comprising:
a transmission module for receiving a read request sent from a client for reading at least one target paragraph in a target file;
a data access module for accessing data content of the target paragraph in the storage media;
a verification value calculation module for computing a verification calculation value corresponding to the target paragraph according to the data content; and
a verification value comparison module for reading from the storage media the verification default value corresponding to the target paragraph and comparing the verification default value and the verification calculation value corresponding to the target paragraph;
wherein the transmission module sends the target paragraph to the client when the verification default value and the verification calculation value corresponding to the target paragraph agree.

6. The system of claim 5, wherein the data access module reads a backup content of the target paragraph when the verification default value and the verification calculation value of the corresponding target paragraph disagree; the verification value calculation module recalculates the verification calculation value corresponding to the target paragraph according to the backup content; and the verification value comparison module further compares the verification default value and the verification calculation value of the corresponding target paragraph.

7. The system of claim 5, wherein the data access module reads the target paragraphs according to the read request.

8. The system of claim 5, wherein the transmission module further receives a write request sent from the client; the data access module further write the target data into the target file; the verification value calculation module further calculates the verification default value corresponding to the updated target paragraph in target file; and the verification database further stores the verification default value corresponding to the updated target paragraph.

9. The system of claim 8 further comprising a request processing module for determining whether the received request is a read request or a write request.

10. The system of claim 5, wherein the size of the target paragraph is set by a default value.
